(19) United States
(12) Patent Application Publication
(10) Pub. No.: US 2006/0251782 A1
(43) Pub. Date: Nov. 9, 2006

(54) Food presentation plank

(76) Inventor: Richard J. Schultz, Media, PA (US)

Correspondence Address: LITMAN LAW OFFICES, LTD, PO BOX 15035, CRYSTAL CITY STATION, ARLINGTON, VA, 22215, US

(21) Appl. No.: 11/417,177

(22) Filed: May 4, 2006

Related U.S. Application Data
(60) Provisional application No. 60/678,808, filed on May 9, 2005.

(51) Int. Cl. A23G 9/26

(52) U.S. Cl. 426/421

(57) ABSTRACT

The food presentation plank is an elongate, planar plank used in the transport of food from the preparation location to the location of presentation for consumption. The plank has handles formed in the ends of the plank, the handles also being dimensioned and configured to receive condiment or sauce dishes. The plank has a liquid collection groove surrounding the food presentation portion of the plank, for collection of liquids coming from food on the plank. This groove eliminates the need for a dam or wall for preventing liquid dripping, and without interfering with the full view of the presentation on the plank. The plank allows a user to prepare for the attractive and appetizing presentation of a catered or gourmet meal in a location remote from that of either the presentation or consumption.

### CROSS-REFERENCE TO RELATED APPLICATION

This application claims the benefit of U.S. Provisional Patent Application Ser. No. 60/678,808, filed May 9, 2005.

### BACKGROUND OF THE INVENTION

1. Field of the Invention

The present invention relates to the field of food display and service, and, more particularly, to a plank used in the transport and artful presentation of food.

2. Description of the Related Art

The art of presentation often plays a key role in the food service industry. For caterers or private chefs, the manner in which the meal is presented largely affects the consumers' opinions of the overall product. Even when someone is hosting an informal private gathering for a large group of people, food presentation is very important to the ambiance of the event.

Most times, catered or gourmet food is prepared in one location and then transported to the location of consumption. This requires the preparer to either add the final preparation touches to the food once the food is organized at the consumption site, or to attempt to transport the food in its final prepared state.

The consumers of the presented food must be able to easily access the food as it sits on the presentation apparatus, without obstruction or danger of getting burned from a hot platter. Often, such as with roast pigs or other meats, juices will drain off of the prepared food, and may create a messy presentation area if not contained. Also, some prepared foods are presented with condiments, sauces, toppings, or other loose side items that should be properly displayed near the main course.

Thus a food presentation plank solving the aforementioned problems is desired.

### SUMMARY OF THE INVENTION

The food presentation plank is an elongate, planar plank used in the transport of food from the preparation location to the location of presentation for consumption. The plank includes handles on either end of the plank, the handles also being dimensioned and configured to receive condiment or sauce dishes. The plank additionally includes a liquid collection groove surrounding the food presentation portion of the plank. The plank has no raised sides that would obstruct the view or access to the food, and may be manufactured from any suitable and sturdy, heat-resistant material.

The plank allows a user to prepare for the attractive presentation of a catered or gourmet meal in a location remote from that of either the presentation or consumption. The plank is of sufficient length and width to support party-length sandwiches, roast meats, assorted dishes grouped in a buffet-style display, and other catered or gourmet meals.

These and other features of the present invention will become readily apparent upon further review of the following specification and drawings.

### BRIEF DESCRIPTION OF THE DRAWINGS

FIG. 1 is an environmental, perspective view of a food presentation plank according to the present invention.

FIG. 2 is a perspective view of a food presentation plank according to the present invention.

FIG. 3 is a cross-sectional view of a food presentation plank according to the present invention.

Similar reference characters denote corresponding features consistently throughout the attached drawings.

### DETAILED DESCRIPTION OF THE PREFERRED EMBODIMENTS

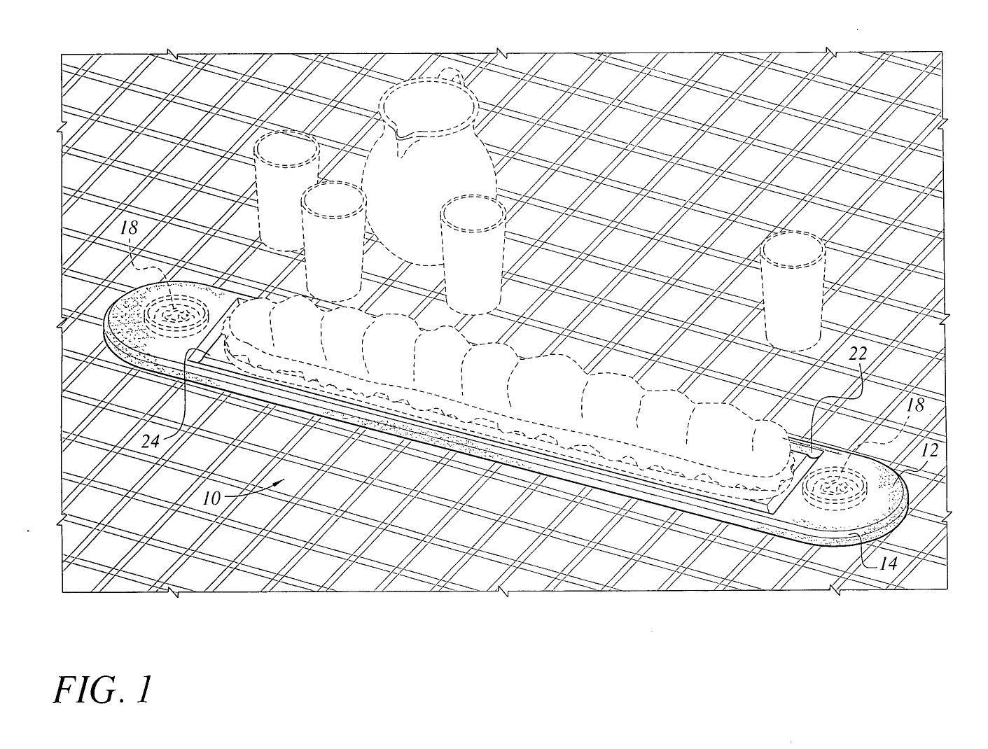

The present invention is a food presentation plank, designated generally as 10 in the drawings. Referring to FIG. 1, the food presentation plank 10 is an elongate, planar plank used in the transport of food from the preparation location to the location of presentation for consumption. Upon reaching the location of presentation for consumption, the plank 10 may then serve as a base for the presentation or display of the meal.

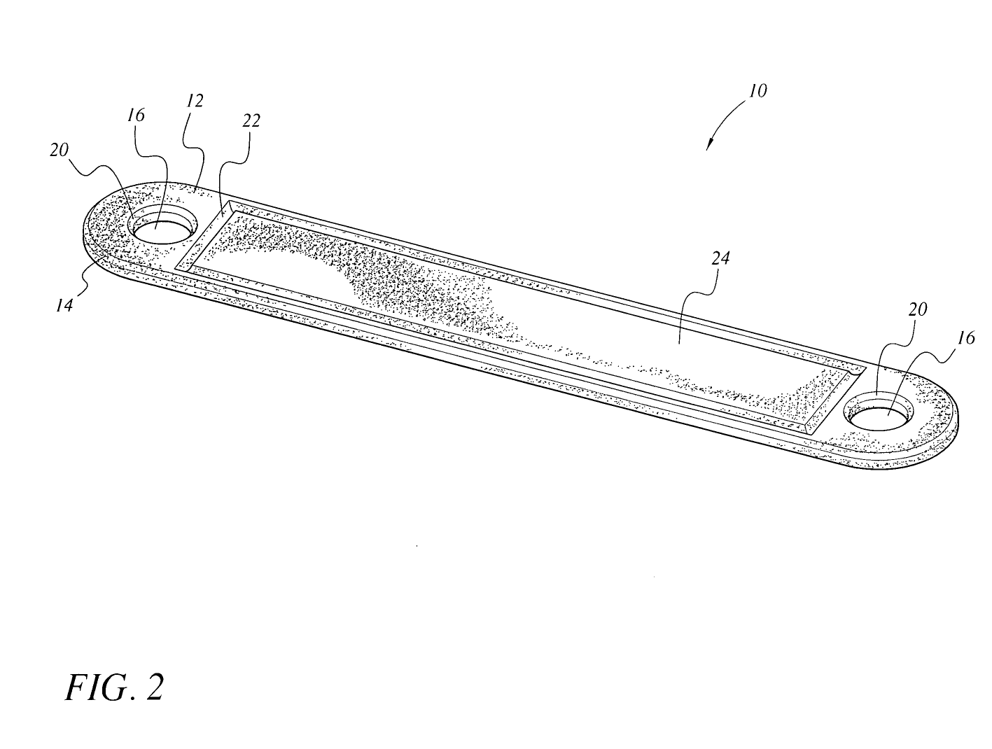

Referring to FIG. 2, the plank 10 includes an elongate, planar board having a top surface 12 and a peripheral edge 14. The peripheral edge 14 is chamfered, preferably, and as shown in the drawings. The ends of the plank 10 may be rounded to prevent injury from sharp corners. Handles 16 are integral with the board 10, and are defined through the board on both ends of the plank 10, the handles 16 also being adapted to receive condiment or sauce dishes 18, as shown in FIG. 1.

The handles include an interior chamfered top edge 20 as seen in FIG. 2. The sauce or condiment dishes 18 may rest on the top surface 12 of the plank 10 and have bases extending down into the handles 16, as shown in FIG. 1, for security of the dishes in place.

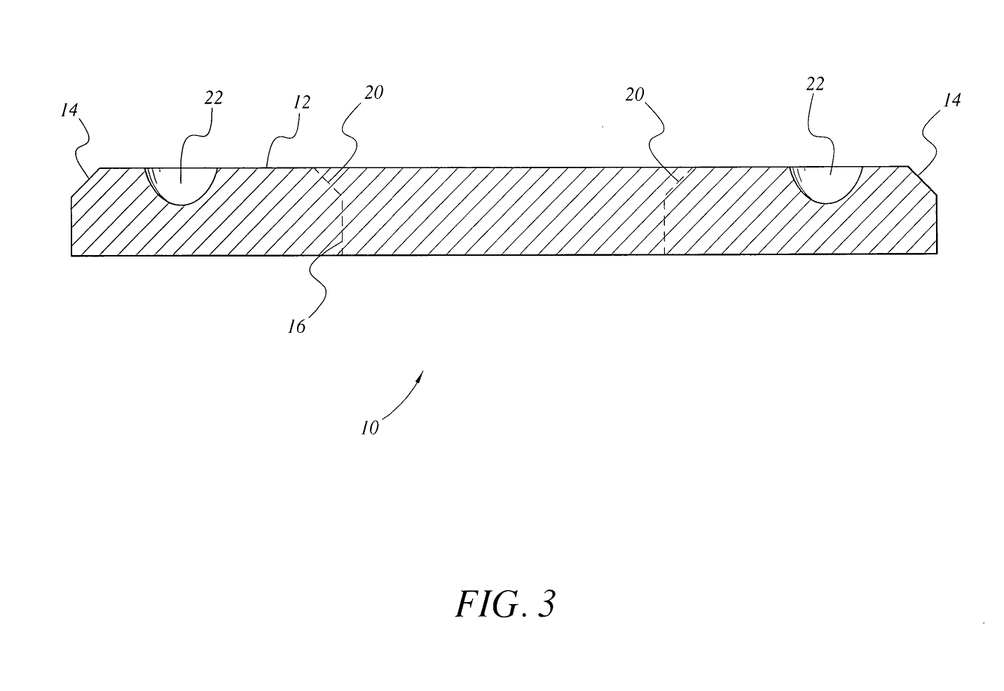

The plank 10 additionally includes a liquid collection groove 22 surrounding and defining the central food presentation island or portion 24 of the top surface 12 of the plank 10. As shown in FIG. 3, the liquid collection groove 22 is a semi-circular or similarly shaped recess cut into the top surface 12 of the plank 10. Groove 22 can be formed by using a router, for example, if plank 10 is made of wood, or by any other suitable method. Any juices or other liquids that may come from the food resting on the food presentation portion 24 of the plank 10 will collect in the surrounding groove 22. The plank 10 has no raised sides that would obstruct the view or access to the food, and may be manufactured from any one or more of suitable materials, for example, a sturdy, heat-resistant material such as oak, maple, or other suitable wood, plastic, metal such as stainless steel, or synthetic material. In the case of metals or plastics, the groove 22 is formed by molding or stamping, by any method known in that art.

The plank 10 allows a user to prepare for the ornamental presentation of a catered or gourmet meal in a location remote from that of either the presentation or consumption. The plank 10 may be of sufficient length and width to support party-length sandwiches, roast meats, assorted dishes grouped in a buffet-style display, and other catered or gourmet meals. For example, the plank 10 may be from 4′ to 8′ long, and 8″ to 24″ wide to support the above-mentioned foods.

It is to be understood that the present invention is not limited to the embodiments described above, but encompasses any and all embodiments within the scope of the following claims.

I claim:

1. A food presentation plank for the transport and presentation of food, comprising:
an elongate planar board having a top surface and a peripheral edge;
a liquid collection groove defined in the top surface, inside of and adjacent to the peripheral edge, said groove forming a continuous, closed loop, such that said groove collects and retain liquids emitted by food resting on the top surface of said board inside the loop; and
at least one handle integral with and defined through each end of said board, wherein said handles are adapted to allow a user to carry said board.

2. The food presentation plank according to claim 1, wherein said handles are dimensioned and configured to receive bowls for use in containing sauces or condiments.

3. The food presentation plank according to claim 1, wherein said peripheral edge is chamfered.

4. The food presentation plank according to claim 1, wherein said plank is between 4 and 8 feet in length.

5. The food presentation plank according to claim 1, wherein said plank has a length in the range of from 4 to 8 feet, and a width of from 8 to 24 inches.

6. The food presentation plank according to claim 1, wherein said plank is made from a material selected from the group consisting of oak, maple, cedar, plastic, metal, or synthetic material.

7. The food presentation plank according to claim 1, wherein said handles are circular, and defined completely through said plank.

8. A food presentation plank for the transport and presentation of food, comprising:
an elongate planar board having a top surface and a peripheral, chamfered edge;
a liquid collection groove defined in the top surface, inside of and adjacent to the peripheral edge, said groove forming a continuous, closed loop, such that said groove collects and retain liquids emitted by food resting on the top surface of said board inside the loop; and
circular handles integral with and defined through each end of said board, said handles being dimensioned and configured for reception of bowls, and to allow a user to carry said board;
said plank being on the order of from 2 to 4 feet in length, and from 8 to 24 inches in width;
said plank being made from a material selected from the group consisting of oak, maple, cedar, plastic, metal, or synthetic material.

9. The food presentation plank according to claim 8, wherein said groove is configured to provide a generally rectangular food presentation surface island within said groove.

10. The food presentation plank according to claim 8, wherein each handle includes an upper, outwardly chamfered surface, for securely assuring the retention of a bowl therewithin.
